(19) United States
(12) Patent Application Publication
(10) Pub. No.: US 2025/0042225 A1
(43) Pub. Date: Feb. 6, 2025

(54) COMPRESSOR MODULE

(71) Applicant: DENSO CORPORATION, Kariya-city (JP)

(72) Inventors: Yuki SUGIYAMA, Kariya-city (JP); Takahiro MAEDA, Kariya-city (JP); Atsushi YAMADA, Kariya-city (JP); Satoshi SUZUKI, Kariya-city (JP); Masayuki TAKEUCHI, Kariya-city (JP); Masaki UCHIYAMA, Kariya-city (JP)

(21) Appl. No.: 18/924,377

(22) Filed: Oct. 23, 2024

Related U.S. Application Data
(63) Continuation of application No. PCT/JP2023/014694, filed on Apr. 11, 2023.

(30) Foreign Application Priority Data
May 13, 2022 (JP) 2022-079356

(51) Int. Cl. B60H 1/32

(52) U.S. Cl. CPC B60H 1/3223; B60H 1/3228; B60H 1/3229

(57) ABSTRACT

A compressor module includes: an evaporator configured to evaporate a refrigerant of a vapor compression refrigeration cycle; a liquid storage configured to store the refrigerant in a liquid phase; a compressor configured to suction and compress the refrigerant; and a flow passage forming member to which the evaporator, the liquid storage and the compressor are installed. The flow passage forming member forms at least a portion of a flow passage of the refrigerant. The compressor is positioned on a lower side of the flow passage forming member, and the flow passage of the refrigerant includes a suction-side refrigerant flow passage, through which the refrigerant in a gas-phase to be suctioned into the compressor flows. The suction-side refrigerant flow passage has a rising portion that rises upward as the rising portion approaches the compressor.

This application is a continuation application of International Patent Application No. PCT/JP2023/014694 filed on Apr. 11, 2023, which designated the U.S. and claims the benefit of priority from Japanese Patent Application No. 2022-79356 filed on May 13, 2022. The entire disclosures of all of the above applications are incorporated herein by reference.

### TECHNICAL FIELD

The present disclosure relates to a compressor module.

### BACKGROUND

Previously, there has been proposed a compressor module that integrates components of a vapor compression refrigeration cycle including a compressor. In this compressor module, constituent devices, such as a compressor, a condenser, an evaporator, a chiller and an accumulator, are placed on a base plate and connected to each other by refrigerant pipes.

### SUMMARY

This section provides a general summary of the disclosure, and is not a comprehensive disclosure of its full scope or all of its features.

According to the present disclosure, there is provided a compressor module including an evaporator, a liquid storage, a compressor and a flow passage forming member. The evaporator is configured to evaporate a refrigerant. The liquid storage is configured to store the refrigerant in a liquid phase. The compressor is configured to suction and compress the refrigerant. The evaporator, the liquid storage and the compressor are installed to the flow passage forming member. The flow passage forming member forms at least a portion of a flow passage of the refrigerant. The compressor is positioned on a lower side of the flow passage forming member. The flow passage of the refrigerant includes a suction-side refrigerant flow passage, through which the refrigerant in a gas phase to be suctioned into the compressor flows. The suction-side refrigerant flow passage has a rising portion that rises upward as the rising portion approaches the compressor.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing an overall structure of a vehicle air conditioning apparatus according to a first embodiment.

FIG. 2 is a perspective view showing a compressor module of the first embodiment.

FIG. 3 is a front view showing the compressor module of the first embodiment.

FIG. 4 is a perspective view showing a flow passage plate of the compressor module of the first embodiment.

FIG. 5 is a side view schematically showing the compressor module of the first embodiment.

FIG. 6 is a cross-sectional view schematically showing a compressor module of a second embodiment.

FIG. 7 is a cross-sectional view schematically showing a flow passage plate of a compressor module of a third embodiment.

### DETAILED DESCRIPTION

Previously, there has been proposed a compressor module that integrates components of a vapor compression refrigeration cycle including a compressor. In this compressor module, constituent devices, such as the compressor, a condenser, an evaporator, a chiller and an accumulator, are placed on a base plate and connected to each other by refrigerant pipes.

In the previously proposed technique described above, the presence of the numerous refrigerant pipes in the confined space makes the routing and connecting work of the refrigerant pipes difficult. As a countermeasure, a refrigerant flow passage may be formed inside the base plate to reduce the number of the refrigerant pipes.

However, a refrigerant suction inlet of the compressor is often located at the top of the compressor. Therefore, when the refrigerant flow passage is formed inside the base plate, a length of the refrigerant flow passage between the base plate and the refrigerant suction inlet of the compressor becomes long, resulting in an increase in the heat loss and/or an increase in the pressure loss. As a countermeasure, it is conceivable to position the compressor on the lower side of the base plate.

However, in the case where the compressor is positioned on the lower side of the base plate, the liquid-phase refrigerant is likely to flow down from the base plate to the compressor due to gravity when the compressor is stopped.

In other words, when the compressor is operating, the gas-phase refrigerant, which is present in the refrigerant flow passage and/or inside the heat exchanger, is condensed and liquefied over time as the compressor stops, and the liquefied refrigerant tends to flow down to the compressor due to the gravity.

When the compressor is restarted with the liquid-phase refrigerant accumulated in the compressor, liquid compression of the liquid-phase refrigerant may occur in the compressor, potentially reducing the compressor's durability.

According to one aspect of the present disclosure, a compressor module includes an evaporator, a liquid storage, a compressor and a flow passage forming member.

The evaporator is configured to evaporate a refrigerant of a vapor compression refrigeration cycle. The liquid storage is configured to store the refrigerant in a liquid phase. The compressor is configured to suction and compress the refrigerant. The evaporator, the liquid storage and the compressor are installed to the flow passage forming member, and the flow passage forming member forms at least a portion of a flow passage of the refrigerant.

The compressor is positioned on a lower side of the flow passage forming member. The flow passage of the refrigerant includes a suction-side refrigerant flow passage, through which the refrigerant in a gas-phase to be suctioned into the compressor flows. The suction-side refrigerant flow passage has a rising portion that rises upward as the rising portion approaches the compressor.

According to this configuration, even when the gas-phase refrigerant releases the heat to the surroundings and is condensed and liquefied at the time of stopping the compressor, the rising portion can limit the liquefied refrigerant from flowing down to the compressor due to the gravity. Therefore, it is possible to limit the occurrence of the liquid compression in the compressor at the time of restarting the compressor.

Hereinafter, embodiments of the present disclosure will be described with reference to the drawings. In each of the following embodiments, the same reference signs may be assigned to portions that are the same as or equivalent to those described in the preceding embodiment(s), and the description thereof may be omitted. Further, when only any one or more of the components are described in the embodiment, the description of the rest of the components described in the preceding embodiment may be applied to the rest of the components. In addition to the combinations of portions that are specifically shown to be combinable in the respective embodiments, it is also possible to partially combine the embodiments even if they are not specifically shown, provided that the combinations are not impeded.

### First Embodiment

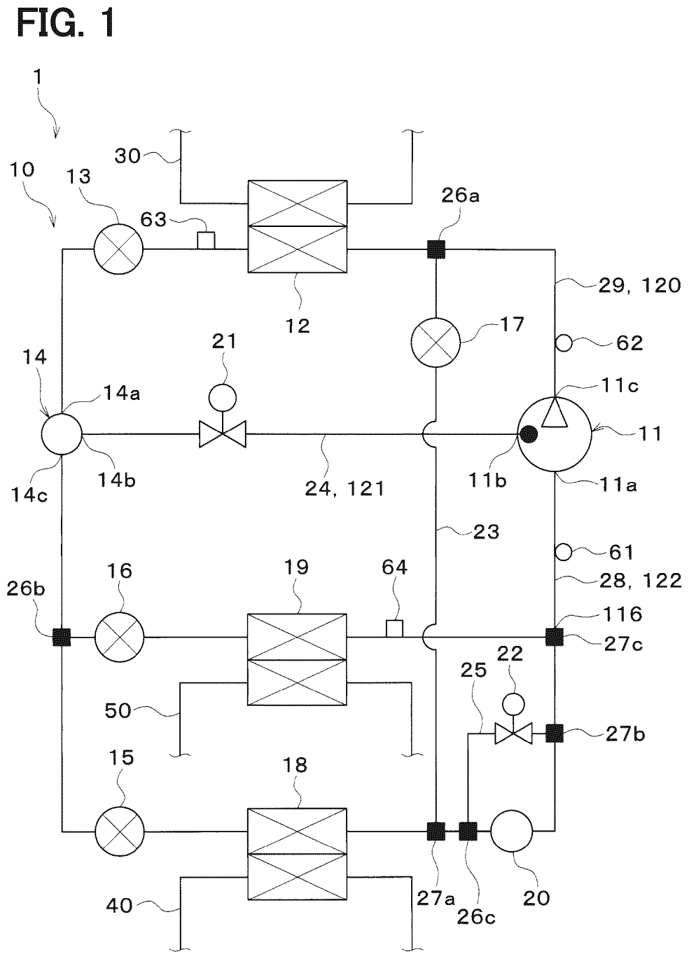

A compressor module of the present embodiment will be described with reference to FIGS. 1 to 5. The compressor module of the present embodiment is applied to a vehicle air conditioning apparatus 1 installed in an electric vehicle. The electric vehicle is a vehicle that obtains its drive force for driving the electric vehicle from an electric motor. The vehicle air conditioning apparatus 1 is a heat pump cycle apparatus that performs air conditioning of a vehicle cabin (i.e., an air conditioning subject space) and also performs temperature adjustment of in-vehicle devices. Therefore, the vehicle air conditioning apparatus 1 can be referred to as an air conditioning apparatus with an in-vehicle device temperature control function, or an in-vehicle device temperature control apparatus with an air conditioning function.

In the vehicle air conditioning apparatus 1, the temperature of a battery (not shown), which serves as the in-vehicle device, is specifically adjusted. The battery is a secondary battery that stores the electrical power to be supplied to the in-vehicle devices that operate electrically. The battery is a battery pack formed by electrically connecting a plurality of stacked battery cells in series or parallel. The battery cells of the present embodiment are lithium-ion batteries.

The battery generates heat during its operation (i.e., during charging and discharging). The battery has the characteristic of easily experiencing a decrease in output at low temperatures and accelerated degradation at high temperatures. Therefore, the temperature of the battery needs to be maintained within an appropriate range (in the present embodiment, a range between 15 degrees Celsius and 55 degrees Celsius). In view of this need, in the electric vehicle of the present embodiment, the temperature of the battery is regulated using the vehicle air conditioning apparatus 1.

The vehicle air conditioning apparatus 1 includes a heat pump cycle 10, a high-temperature heat medium circuit 30, a first low-temperature heat medium circuit 40, a second low-temperature heat medium circuit 50, an indoor air conditioning unit (not shown) and a control device (not shown).

The heat pump cycle 10 is a vapor compression refrigeration cycle apparatus that adjusts the temperature of the high-temperature heat medium circulating through the high-temperature heat medium circuit 30, the temperature of the low-temperature heat medium circulating through the first low-temperature heat medium circuit 40, and the temperature of the low-temperature heat medium circulating through the second low-temperature heat medium circuit 50. The heat pump cycle 10 is configured to switch the refrigerant circuit according to various operation modes for the air conditioning of the vehicle cabin and the cooling of the in-vehicle devices.

The heat pump cycle 10 includes a compressor 11, a condenser 12, an intermediate-pressure expansion valve 13, a gas-liquid separator 14, an air-cooling expansion valve 15, a cooling expansion valve (also referred to as a device-cooling expansion valve) 16, a hot-gas flow rate control valve 17, an air conditioning chiller 18, a cooling chiller (also referred to as a device-cooling chiller) 19, an accumulator 20, an intermediate-pressure on-off valve 21 and a bypass on-off valve 22.

The heat pump cycle 10 uses an HFO refrigerant (specifically, R1234yf) as the refrigerant. The heat pump cycle 10 forms a subcritical refrigeration cycle in which the pressure of the high-pressure side refrigerant does not exceed the critical pressure of the refrigerant. The refrigerant contains a refrigerating machine oil for lubricating the compressor 11. The refrigerating machine oil is a PAG oil that is miscible with the liquid-phase refrigerant. A portion of the refrigerating machine oil circulates through the cycle along with the refrigerant.

The compressor 11 is configured to suction, compress and discharge the refrigerant in the heat pump cycle 10. The compressor 11 is an electric compressor that drives a fixed displacement compression mechanism, which has a fixed discharge capacity, by using an electric motor. A rotational speed (i.e., a refrigerant discharge capacity) of the compressor 11 is controlled by a control signal outputted from the control device.

The compressor 11 is a two-stage pressure boosting electric compressor. The compressor 11, which is the two-stage pressure boosting electric compressor, receives two compression mechanisms (i.e., a low-stage compression mechanism and a high-stage compression mechanism) and the electric motor that drives these two compression mechanisms, within a housing that forms an outer shell of the compressor 11.

A suction port 11a, an intermediate-pressure port 11b and a discharge port 11c are formed at the housing of the compressor 11. The suction port 11a is a suction inlet for suctioning the low-pressure refrigerant from the outside of the housing into the low-stage compression mechanism. The discharge port 11c is a discharge outlet for discharging the high-pressure refrigerant outputted from the high-stage compression mechanism to the outside of the housing.

The intermediate-pressure port 11b is an intermediate-pressure suction inlet for allowing the intermediate-pressure refrigerant to flow from the outside of the housing to the inside of the housing and merge with the refrigerant which is in a compression process from the low pressure to high pressure. That is, the intermediate-pressure port 11b is connected to the discharge outlet of the low-stage compression mechanism and the suction inlet of the high-stage compression mechanism at the inside of the housing.

The compressor 11 of the present embodiment receives the two compression mechanisms within the single housing, but the configuration of the two-stage pressure boosting compressor is not limited to this. The compressor 11 of the present embodiment may be an electric compressor that receives a single fixed displacement compression mechanism and an electric motor that rotationally drives the compression mechanism within a housing, as long as it is capable of allowing the intermediate-pressure refrigerant to flow in from the intermediate-pressure port 11b and merge with the refrigerant which is in the compression process from the low pressure to the high pressure.

The compressor 11 of the present embodiment may be an electric compressor that includes two compressors connected in series. This electric compressor has: the suction port 11a serving as the suction inlet of the low-stage compressor positioned on the low-pressure side; the discharge port 11c serving as the discharge outlet of the high-stage compressor positioned on the high-pressure side; and the intermediate-pressure port 11b provided at a connection between the discharge outlet of the low-stage compressor and the suction inlet of the high-stage compressor, and the low-stage compressor and the high-stage compressor form a two-stage pressure boosting compressor.

The condenser 12 is a heat exchanger that exchanges heat between the refrigerant discharged from the compressor 11 and the high-temperature heat medium of the high-temperature heat medium circuit 30. In the condenser 12, the heat of the refrigerant discharged from the compressor 11 is released to the high-temperature heat medium, which is a heating-subject fluid, thereby heating the high-temperature heat medium.

A high-temperature heat medium pump, a heater core, a radiator, a switching valve and an electric heater (all not shown) are installed in the high-temperature heat medium circuit 30. The high-temperature heat medium pump suctions and discharges the high-temperature heat medium of the high-temperature heat medium circuit 30. The heater core is a heat exchanger that heats the air by exchanging the heat between the high-temperature heat medium of the high-temperature heat medium circuit 30 and the air to be blown into the vehicle cabin. The high-temperature heat medium of the high-temperature heat medium circuit 30 is, for example, an ethylene glycol aqueous solution.

The radiator is a heat exchanger that heats the air by exchanging heat between the high-temperature heat medium of the high-temperature heat medium circuit 30 and the outside air outside the vehicle cabin. The switching valve switches the state of the high-temperature heat medium in the high-temperature heat medium circuit 30 between a state of flowing through the heater core and a state of flowing through the radiator. The electric heater is a heat medium heater that generates heat when supplied with electric power and heats the high-temperature heat medium of the high-temperature heat medium circuit 30.

The intermediate-pressure expansion valve 13 is a decompressor that reduces the pressure of the refrigerant outputted from the condenser 12 and adjusts the flow rate of the refrigerant to be outputted to the downstream side thereof. The operation of the intermediate-pressure expansion valve 13 is controlled by a control signal (specifically, a control pulse) outputted from the control device. Therefore, the intermediate-pressure expansion valve 13 is an electric device. The intermediate-pressure expansion valve 13 has a full-opening function that allows it to act merely as a refrigerant flow passage without significantly performing both a flow rate adjusting function and a refrigerant depressurizing function by fully opening its throttle passage.

The gas-liquid separator 14 includes a refrigerant inlet 14a, a gas-phase refrigerant outlet 14b and a liquid-phase refrigerant outlet 14c. The refrigerant, which is outputted from the intermediate-pressure expansion valve 13, flows into the refrigerant inlet 14a. The gas-liquid separator 14 separates the gas-liquid mixture of the refrigerant, which is inputted from the refrigerant inlet 14a, so that the separated gas-phase refrigerant is outputted from the gas-liquid separator 14 through the gas-phase refrigerant outlet 14b, and the separated liquid-phase refrigerant is outputted from the gas-liquid separator 14 through the liquid-phase refrigerant outlet 14c.

Each of the air-cooling expansion valve 15 and the cooling expansion valve 16 is a decompressor that reduces the pressure of the refrigerant outputted from the liquid-phase refrigerant outlet 14c of the gas-liquid separator 14 and adjusts the flow rate of the refrigerant to be outputted to the downstream side thereof. The basic structure of each of the air-cooling expansion valve 15 and the cooling expansion valve 16 is substantially the same as that of the intermediate-pressure expansion valve 13. Therefore, each of the air-cooling expansion valve 15 and the cooling expansion valve 16 is an electric device. Each of the air-cooling expansion valve 15 and the cooling expansion valve 16 has a full closing function for closing the refrigerant flow passage by fully closing its throttle passage.

The hot-gas flow rate control valve 17 is an electric variable throttle mechanism that reduces the pressure of the refrigerant flowing through a hot-gas flow passage 23 and adjusts the flow rate of the refrigerant to be outputted to the downstream side thereof. The basic structure of the hot-gas flow rate control valve 17 is substantially the same as that of the intermediate-pressure expansion valve 13. Therefore, the hot-gas flow rate control valve 17 is an electric device. The hot-gas flow rate control valve 17 has a full closing function for closing the refrigerant flow passage by fully closing its throttle passage.

The air conditioning chiller 18 is a heat exchanger that exchanges heat between the low-pressure refrigerant decompressed by the air-cooling expansion valve 15 and the low-temperature heat medium of the first low-temperature heat medium circuit 40. The air conditioning chiller 18 is an evaporator that cools the low-temperature heat medium by evaporating the low-pressure refrigerant to perform a heat absorbing function.

A first low-temperature heat medium pump and a cooler core (both not shown) are installed in the first low-temperature heat medium circuit 40. The first low-temperature heat medium pump suctions and discharges the low-temperature heat medium of the first low-temperature heat medium circuit 40. The cooler core is a heat exchanger that cools the air by exchanging the heat between the low-temperature heat medium of the first low-temperature heat medium circuit 40 and the air to be blown into the vehicle cabin. The low-temperature heat medium of the first low-temperature heat medium circuit 40 is, for example, the ethylene glycol aqueous solution.

The cooling chiller 19 is a heat exchanger that exchanges heat between the low-pressure refrigerant decompressed by the cooling expansion valve 16 and the low-temperature heat medium of the second low-temperature heat medium circuit 50. The cooling chiller 19 is an evaporator that cools the low-temperature heat medium by evaporating the low-pressure refrigerant to perform a heat absorbing function.

A second low-temperature heat medium pump and a battery (both not shown) are installed in the second low-temperature heat medium circuit 50. The second low-temperature heat medium pump suctions and discharges the low-temperature heat medium of the second low-temperature heat medium circuit 50. The cooler core cools the battery. This is achieved by circulating the low-temperature heat medium of the second low-temperature heat medium circuit 50 through a heat medium flow passage of the battery, allowing the low-temperature heat medium to absorb heat from the battery. The low-temperature heat medium of the second low-temperature heat medium circuit 50 is, for example, the ethylene glycol aqueous solution.

The accumulator 20 is a low-pressure-side gas-liquid separator that separates the gas-liquid mixture of the refrigerant flowing into the accumulator 20 and stores the excess liquid-phase refrigerant in the cycle. The accumulator 20 serves as a liquid storage.

The intermediate-pressure on-off valve 21 is a solenoid valve that opens and closes an intermediate-pressure flow passage 24. The intermediate-pressure on-off valve 21 is the solenoid valve whose opening and closing operation is controlled by a control voltage output from the control device. Therefore, the intermediate-pressure on-off valve 21 is an electric device. The intermediate-pressure flow passage 24 is connected to the gas-phase refrigerant outlet 14b of the gas-liquid separator 14 and the intermediate-pressure port 11b of the compressor 11.

The bypass on-off valve 22 is a solenoid valve that opens and closes a bypass flow passage 25. The bypass on-off valve 22 is the solenoid valve whose opening and closing operation is controlled by a control voltage output from the control device. Therefore, the bypass on-off valve 22 is an electric device.

The heat pump cycle 10 includes a first branch 26a, a second branch 26b and a third branch 26c each of which splits the flow of the refrigerant. The heat pump cycle 10 includes a first junction 27a, a second junction 27b and a third junction 27c each of which merges the flows of the refrigerant.

The first branch 26a splits the flow of the refrigerant discharged from the compressor 11 into the flow directed toward the condenser 12 and the flow directed toward the hot-gas flow passage 23. The second branch 26b splits the flow of the liquid-phase refrigerant outputted from the liquid-phase refrigerant outlet 14c of the gas-liquid separator 14 into the flow directed toward the air-cooling expansion valve 15 and the flow directed toward the cooling expansion valve 16. The third branch 26c splits the flow of the refrigerant, which has merged at the first junction 27a, into the flow directed toward the accumulator 20 and the flow directed toward the bypass flow passage 25.

The first junction 27a merges the flow of the refrigerant outputted from the hot-gas flow passage 23 with the flow of the refrigerant evaporated in the air conditioning chiller 18. The second junction 27b merges the flow of the refrigerant outputted from the bypass flow passage 25 with the flow of the gas-phase refrigerant outputted from the accumulator 20. The third junction 27c merges the flow of the refrigerant evaporated in the cooling chiller 19 with the flow of the refrigerant merged at the second junction 27b.

A suction-side refrigerant flow passage 28 is connected between the refrigerant outlet of the third junction 27c and the suction port 11a of the compressor 11.

The indoor air conditioning unit (not shown) is a unit that integrates a plurality of components to discharge the air, the temperature of which is adjusted to an appropriate temperature for air conditioning of the vehicle cabin, to appropriate locations in the vehicle cabin. The indoor air conditioning unit is located inside the instrument panel placed at the frontmost part of the vehicle cabin.

The indoor air conditioning unit is formed by housing an indoor blower (not shown), the cooler core, the heater core and others at an inside of an air conditioning case (not shown) that forms the air passage.

The heat pump cycle 10 includes a group of refrigerant pressure sensors and a group of refrigerant temperature sensors. The group of refrigerant pressure sensors includes a suction-side refrigerant pressure sensor 61 and a discharge-side refrigerant pressure sensor 62. The suction-side refrigerant pressure sensor 61 is a refrigerant pressure sensor that senses the pressure of the refrigerant to be suctioned into the suction port 11a of the compressor 11. The discharge-side refrigerant pressure sensor 62 is a refrigerant pressure sensor that senses the pressure of the refrigerant discharged from the discharge port 11c of the compressor 11.

The group of refrigerant temperature sensors includes a condensed refrigerant temperature sensor 63 and an evaporated refrigerant temperature sensor 64. The condensed refrigerant temperature sensor 63 is a refrigerant temperature sensor that senses the temperature of the refrigerant outputted from the condenser 12. The evaporated refrigerant temperature sensor 64 is a refrigerant temperature sensor that senses the temperature of the refrigerant outputted from the cooling chiller 19.

The measurement signals from the group of refrigerant pressure sensors and the group of refrigerant temperature sensors are inputted to the control device. The control device includes a well-known microcomputer, which includes a CPU, a ROM and a RAM, and peripheral circuits thereof. The control device executes various calculations and operations according to a control program stored in the ROM. Furthermore, the control device controls the operations of the various control subject devices connected to the output side of the control device based on the result of the calculations and operations of the control device.

An operation panel (not shown) is connected to the input side of the control device. The operation panel is located near the instrument panel at the front of the vehicle cabin and has various operation switches. Operation signals, which are outputted from the various operation switches provided on the operation panel, are inputted to the control device.

The various operation switches provided on the operation panel include, specifically, an auto mode switch, an air conditioning switch, an air flow rate setting switch and a temperature setting switch.

The auto mode switch is an operation switch that sets or cancels the automatic control operation of the vehicle air conditioning apparatus 1. The air conditioning switch is an operation switch that requests the cooling of the air by the cooler core. The air flow rate setting switch is an operation switch that manually sets the air flow rate (i.e., the air flow rate of the indoor blower) of the air to be blown into the vehicle cabin. The temperature setting switch is an operation switch that sets a set temperature of the vehicle cabin.

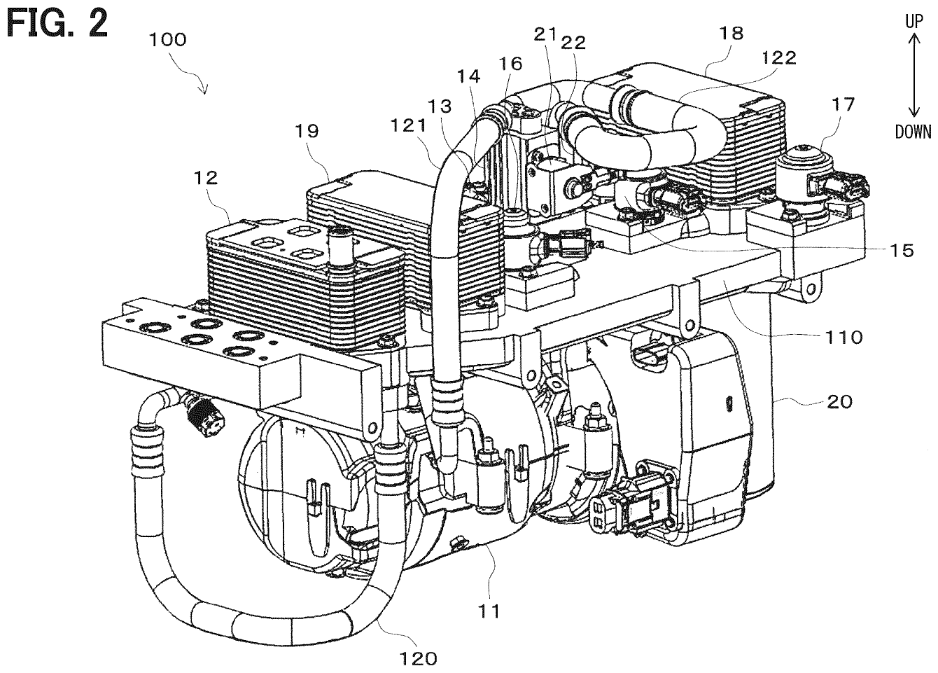

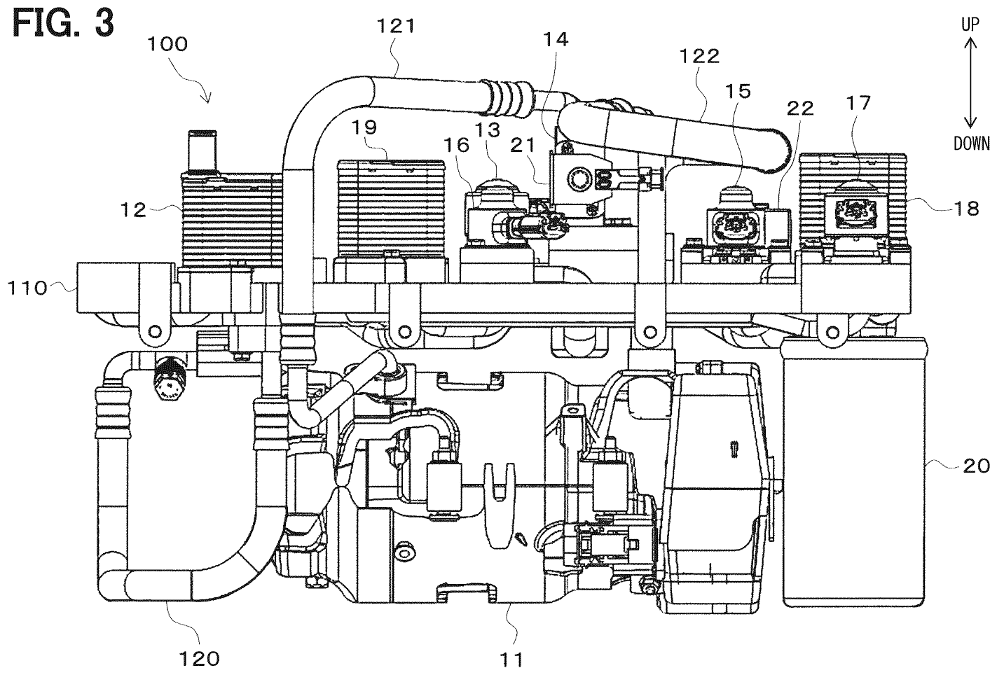

A compressor module 100 shown in FIGS. 2 and 3 is a component that integrates the plurality of constituent devices, which constitute the heat pump cycle 10. A double-sided arrow in the up-down direction in FIGS. 2 and 3 indicates the up-down direction of the electric vehicle in which the compressor module 100 is installed.

In the compressor module 100 of the present embodiment, the constituent devices of the heat pump cycle 10, including the compressor 11, the condenser 12, the intermediate-pressure expansion valve 13, the gas-liquid separator 14, the air-cooling expansion valve 15, the cooling expansion valve 16, the hot-gas flow rate control valve 17, the air conditioning chiller 18, the cooling chiller 19, the accumulator 20, the intermediate-pressure on-off valve 21 and the bypass on-off valve 22, are integrated.

These constituent devices are integrated when these constituent devices are installed to a flow passage plate 110 of the compressor module 100. Therefore, the flow passage plate 110 is a mounting member, to which the plurality of constituent devices are installed.

The flow passage plate 110 is formed by casting metal (an aluminum alloy in the present embodiment). The flow passage plate 110 is shaped in a plate form that extends in the horizontal direction.

The condenser 12, the intermediate-pressure expansion valve 13, the gas-liquid separator 14, the air-cooling expansion valve 15, the cooling expansion valve 16, the hot-gas flow rate control valve 17, the air conditioning chiller 18, the cooling chiller 19 and the bypass on-off valve 22 are fixed to an upper surface of the flow passage plate 110. The intermediate-pressure on-off valve 21 is integrated with the gas-liquid separator 14.

The compressor 11 and the accumulator 20 are fixed to a lower surface of the flow passage plate 110. A bracket (not shown) is installed to an outer peripheral surface of the flow passage plate 110. The bracket is a member that is used to fix the compressor module 100 to the vehicle. For example, the bracket extends toward the lower side across the compressor 11 and the accumulator 20.

The flow passage plate 110 serves as a flow passage forming member that has: a plurality of refrigerant flow passages, which conduct the refrigerant of the heat pump cycle 10; a plurality of heat medium flow passages, which conduct the high-temperature heat medium of the high-temperature heat medium circuit 30; and a plurality of heat medium flow passages, which conduct the low-temperature heat medium of the first low-temperature heat medium circuit 40 and the low-temperature heat medium of the second low-temperature heat medium circuit 50.

The first branch 26a, the second branch 26b, the third branch 26c, the first junction 27a, the second junction 27b and the third junction 27c are formed at the inside of the flow passage plate 110.

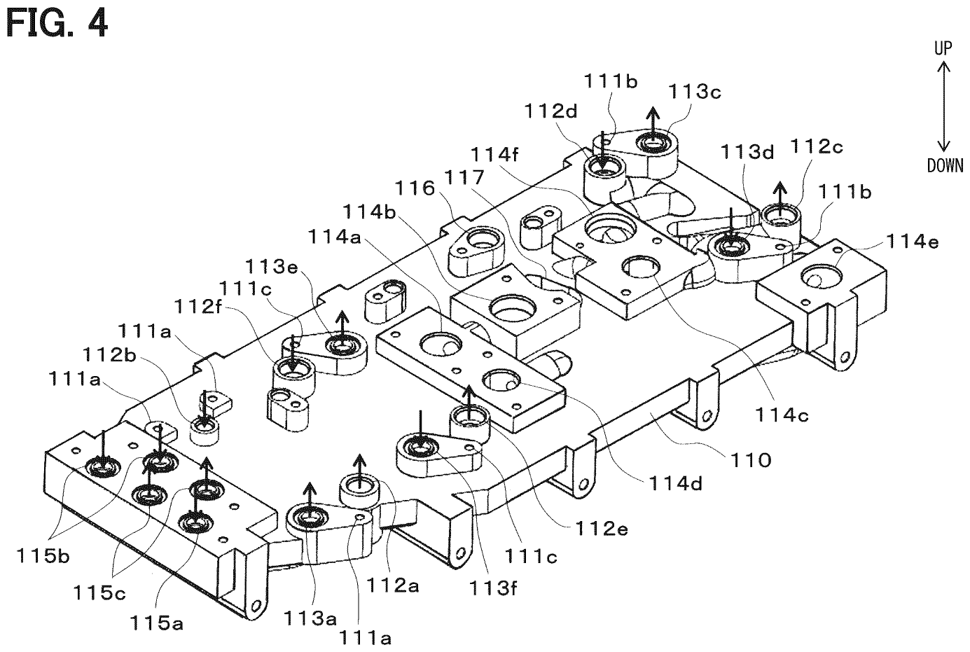

As shown in FIG. 4, a plurality of seats 111a for fixing the condenser 12; a plurality of seats 111b for fixing the air conditioning chiller 18; and a plurality of seats 111c for fixing the cooling chiller 19 are formed at the upper surface of the flow passage plate 110. A double-sided arrow in the up-down direction in FIG. 4 indicates the up-down direction of the electric vehicle in which the compressor module 100 is installed.

An outlet 112a of the refrigerant to the condenser 12, an inlet 112b of the refrigerant from the condenser 12, an outlet 112c of the refrigerant to the air conditioning chiller 18, an inlet 112d of the refrigerant from the air conditioning chiller 18, an outlet 112e of the refrigerant to the cooling chiller 19 and an inlet 112f of the refrigerant from the cooling chiller 19 are formed at the upper surface of the flow passage plate 110.

An outlet 113a of the high-temperature heat medium to the condenser 12, an outlet 113c of the low-temperature heat medium to the air conditioning chiller 18, an inlet 113d of the low-temperature heat medium from the air conditioning chiller 18, an outlet 113e of the low-temperature heat medium to the cooling chiller 19 and an inlet 113f of the low-temperature heat medium from the cooling chiller 19 are formed at the upper surface of the flow passage plate 110.

An installation hole 114a for installing the intermediate-pressure expansion valve 13, an installation hole 114b for installing the gas-liquid separator 14, an installation hole 114c for installing the air-cooling expansion valve 15, an installation hole 114d for installing the cooling expansion valve 16, an installation hole 114e for installing the hot-gas flow rate control valve 17 and an installation hole 114f for installing the bypass on-off valve 22 are formed at the upper surface of the flow passage plate 110.

A high-temperature heat medium inlet 115a for inputting the high-temperature heat medium, a plurality of low-temperature heat medium inlets 115b for inputting the low-temperature heat medium and a plurality of high-temperature heat medium outlets 115c for outputting the high-temperature heat medium are formed at the upper surface of the flow passage plate 110.

A suction-side refrigerant outlet 116 is formed at the upper surface of the flow passage plate 110. The suction-side refrigerant outlet 116 is a refrigerant outlet of the third junction 27c. That is, the suction-side refrigerant outlet 116 is configured to output the refrigerant and is joined with the suction-side refrigerant pipe 122.

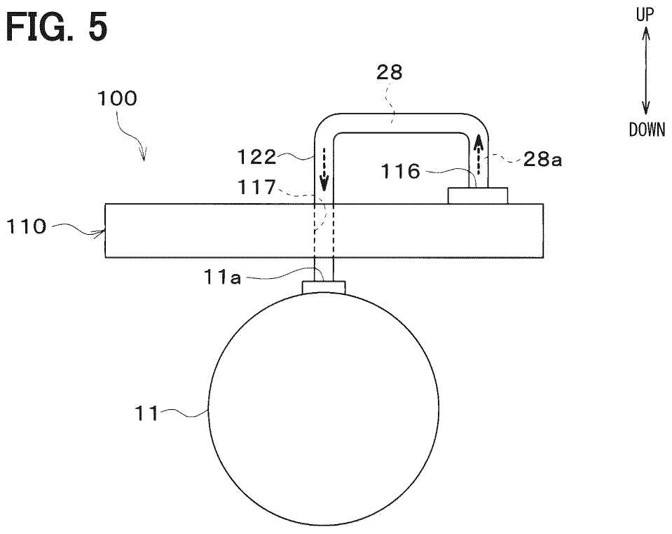

As shown in FIGS. 2, 3 and 5, a discharge-side refrigerant pipe 120, an intermediate-pressure refrigerant pipe 121 and a suction-side refrigerant pipe 122 are arranged at the outside of the flow passage plate 110. A double-sided arrow in the up-down direction in FIG. 5 indicates the up-down direction of the electric vehicle in which the compressor module 100 is installed.

The discharge-side refrigerant pipe 120 is a flow passage forming member which forms a refrigerant flow passage 29 between the discharge port 11c of the compressor 11 and the first branch 26a shown in FIG. 1.

The intermediate-pressure refrigerant pipe 121 is a flow passage forming member that forms a flow passage between the intermediate-pressure on-off valve 21 and the intermediate-pressure port 11b of the compressor 11 in the intermediate-pressure flow passage 24 shown in FIG. 1. The suction-side refrigerant pipe 122 is a flow passage forming member which forms the suction-side refrigerant flow passage 28 (also referred to as a pipe member which forms a passage of the refrigerant extending from the flow passage plate 110 to the compressor 11 in the suction-side refrigerant flow passage 28).

As schematically shown in FIG. 5, the suction-side refrigerant pipe 122 rises upward from the suction-side refrigerant outlet 116 opened at the upper surface of the flow passage plate 110, then descends towards a through-hole 117 of the flow passage plate 110, further passes through the through-hole 117 of the flow passage plate 110, descends below the flow passage plate 110, and connects to the suction port 11a of the compressor 11.

A portion of the suction-side refrigerant pipe 122, which rises upward from the suction-side refrigerant outlet 116 of the third junction 27c, forms a rising portion 28a that elevates the suction-side refrigerant flow passage 28 in the direction of gravity.

Next, the operation of the vehicle air conditioning apparatus 1 of the present embodiment having the above-described structure will be described. In the vehicle air conditioning apparatus 1 of the present embodiment, the operation mode is switched among various operation modes to perform the air conditioning in the vehicle cabin and the temperature adjustment of the battery. The switching of the operation mode among the various operation modes is performed by executing the control program prestored in the control device. The control device controls the operations of the intermediate-pressure expansion valve 13, the air-cooling expansion valve 15, the cooling expansion valve 16, the hot-gas flow rate control valve 17, the intermediate-pressure on-off valve 21 and the bypass on-off valve 22 to switch the operation mode.

The various operation modes of the vehicle air conditioning apparatus 1 include, for example, a standalone air-cooling mode, a cooling and air-cooling mode, a standalone dehumidifying and air-heating mode, a cooling and dehumidifying and air-heating mode and a standalone cooling mode.

The standalone air-cooling mode is an operation mode that performs the air-cooling of the vehicle cabin by blowing the air cooled by the cooler core into the vehicle cabin.

The cooling and air-cooling mode is an operation mode that performs the air-cooling in the vehicle cabin by blowing the air cooled by the cooler core into the vehicle cabin, while also cooling the battery using the low-temperature heat medium cooled by the cooling chiller 19.

The standalone dehumidifying and air-heating mode is an operation mode that performs dehumidifying and air-heating in the vehicle cabin by blowing the air which is cooled by the cooler core and then heated by the heater core, into the vehicle cabin.

The cooling and dehumidifying and air-heating mode is an operation mode that performs dehumidifying and air-heating in the vehicle cabin by blowing air, which is cooled by the cooler core and then heated by the heater core, into the vehicle cabin, while also cooling the battery using the low-temperature heat medium cooled by the cooling chiller 19.

The standalone cooling mode is an operation mode that cools the battery using the low-temperature heat medium cooled by the cooling chiller 19.

By placing the hot-gas flow rate control valve 17 into the throttled state, the low-enthalpy refrigerant, which has a low enthalpy and is discharged from at least one of the air conditioning chiller 18 and the cooling chiller 19, is mixed with the refrigerant which has a high enthalpy and is outputted from the hot-gas flow passage 23, and this mixed refrigerant is suctioned into the compressor 11.

The control device controls a throttling opening degree of the hot-gas flow rate control valve 17 so that a degree of superheat of the refrigerant to be suctioned into the compressor 11 approaches a target degree of superheat, and thereby the control device can ensure that the state of the refrigerant to be suctioned into the compressor 11 becomes the gas-phase refrigerant having the degree of superheat.

By placing the intermediate-pressure on-off valve 21 in a valve open state, the intermediate-pressure refrigerant in the gas phase passed through the intermediate-pressure expansion valve 13 and the gas-liquid separator 14 can flow into the intermediate-pressure port 11b of the compressor 11. Therefore, it is possible to merge the intermediate-pressure refrigerant, which is in the gas phase and has passed through the intermediate-pressure expansion valve 13 and the gas-liquid separator 14, with the refrigerant which is suctioned through the suction port 11a and is in a pressure-boosting process in the compressor 11. That is, the heat pump cycle 10 can form a gas injection cycle.

By placing the bypass on-off valve 22 in the valve open state, it is possible to direct a portion of the refrigerant, which is merged at the first junction 27a, into the bypass flow passage 25 by bypassing the accumulator 20. In this way, a pressure loss of the refrigerant can be reduced in the accumulator 20, and thereby the performance of the heat pump cycle 10 can be improved.

In these operation modes, the refrigerant flow passage of the heat pump cycle 10 has a region, in which the liquid-phase refrigerant flows, and a region, in which the gas-phase refrigerant flows. The gas-phase refrigerant, which is decompressed through the hot-gas flow rate control valve 17, the gas-phase refrigerant, which is evaporated at the air conditioning chiller 18, and the gas-phase refrigerant, which is evaporated at the cooling chiller 19, are suctioned from the third junction 27c into the suction port 11a of the compressor 11 through the suction-side refrigerant flow passage 28 in the suction-side refrigerant pipe 122.

When the operation of the heat pump cycle 10 stops (in other words, when the compressor 11 stops), the gas-phase refrigerant having the high temperature in the refrigerant flow passage, the gas-phase refrigerant in the air conditioning chiller 18, and the gas-phase refrigerant in the cooling chiller 19 release heat to the surroundings over time and gradually condense into liquid (i.e., the refrigerant in the liquid phase, also referred to as the liquid-phase refrigerant).

The refrigerant, which has condensed into the liquid during the shutdown of the operation of the heat pump cycle 10, flows down through the refrigerant flow passage of the heat pump cycle 10 due to the action of gravity. When the refrigerant, which has condensed into the liquid during the shutdown of the operation of the heat pump cycle 10, flows down and enters the suction port 11a of the compressor 11 from the flow passage plate 110, there is a risk that when the heat pump cycle 10 is restarted (in other words, when the compressor 11 is restarted), the liquid-phase refrigerant accumulated in the compressor 11 will be compressed, potentially deteriorating the durability of the compressor 11.

In this regard, in the present embodiment, since the suction-side refrigerant pipe 122 rises upward from the suction-side refrigerant outlet 116 of the flow passage plate 110, it is possible to limit the refrigerant, which has condensed into the liquid during the shutdown of the operation of the heat pump cycle 10, from flowing down into the suction port 11a of the compressor 11 due to gravity. Therefore, it is possible to limit the occurrence of liquid compression of the liquid-phase refrigerant in the compressor 11 at the time of restarting the compressor 11.

In the present embodiment, the compressor 11 is positioned on the lower side of the flow passage plate 110, and the suction-side refrigerant flow passage 28 has the rising portion 28a that rises upward as the rising portion 28a approaches the compressor 11.

According to this configuration, even when the gas-phase refrigerant releases the heat to the surroundings and is condensed and liquefied at the time of stopping the compressor 11, the rising portion 28a can limit the liquefied refrigerant from flowing down from the flow passage plate 110 to the compressor 11 due to the gravity. Therefore, it is possible to limit the occurrence of the liquid compression in the compressor 11 at the time of restarting the compressor 11.

In the present embodiment, the accumulator 20 is positioned on the lower side of the flow passage plate 110. According to this configuration, when the compressor 11 is stopped, the liquefied refrigerant is more likely to flow down to the accumulator 20 and is accumulated in the accumulator 20 due to the gravity. Therefore, the liquefied refrigerant can be limited from flowing down from the flow passage plate 110 to the compressor 11 due to the gravity, and thereby it is possible to limit the occurrence of the liquid compression at the time of restarting the compressor 11.

In the present embodiment, the air conditioning chiller 18 and the cooling chiller 19 are positioned on the upper side of the flow passage plate 110. Thereby, the air conditioning chiller 18 and the cooling chiller 19 can be positioned on the upper side of the flow passage plate 110, and the compressor 11 can be positioned on the lower side of the flow passage plate 110 separately from the air conditioning chiller 18 and the cooling chiller 19.

In the present embodiment, the rising portion 28a is formed by the suction-side refrigerant pipe 122 rising upward from the suction-side refrigerant outlet 116 of the flow passage plate 110. Therefore, the rising portion 28a can be easily formed.

In the present embodiment, the flow passage plate 110 is a horizontally extending plate member, and the compressor 11 is fixed to the lower surface of the flow passage plate 110. Therefore, the compressor 11 and the other constituent devices of the heat pump cycle 10 can be efficiently installed to the flow passage plate 110.

### Second Embodiment

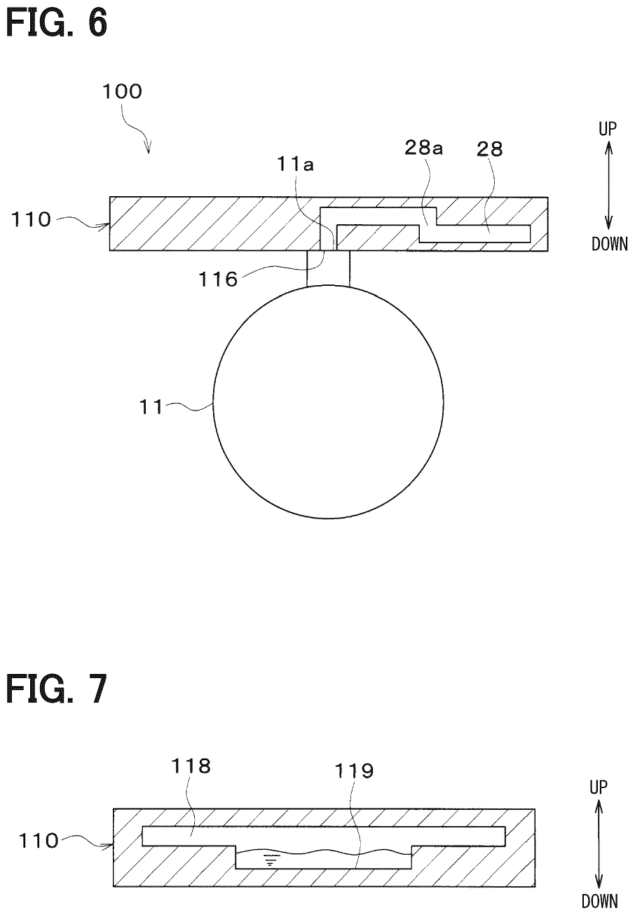

In the first embodiment described above, the suction-side refrigerant flow passage 28 is formed by the suction-side refrigerant pipe 122. However, in the present embodiment, as shown in FIG. 6, the suction-side refrigerant flow passage 28 is formed inside the flow passage plate 110, and the rising portion 28a of the suction-side refrigerant flow passage 28 is formed inside the flow passage plate 110. A double-sided arrow in the up-down direction in FIG. 6 indicates the up-down direction of the electric vehicle in which the compressor module 100 is installed.

In the present embodiment, the suction-side refrigerant outlet 116 is formed at the lower surface of the flow passage plate 110 and is directly coupled to the suction port 11a of the compressor 11.

As in the first embodiment described above, the rising portion 28a of the suction-side refrigerant flow passage 28 can limit the condensed liquefied refrigerant, which is condensed and liquified during the shutdown of the operation, from flowing down to the compressor 11, thereby limiting the occurrence of the liquid compression at the time of restarting the compressor 11.

In the present embodiment, since the rising portion 28a is formed inside the flow passage plate 110, it is possible to form the rising portion 28a while minimizing the increase in the size of the compressor module 100.

### Third Embodiment

In the present embodiment, as shown in FIG. 7, a refrigerant flow passage 118 formed inside the flow passage plate 110 has a liquid reservoir 119 that is recessed toward the lower side at the refrigerant flow passage 118. A double-sided arrow in the up-down direction in FIG. 7 indicates the up-down direction of the electric vehicle in which the compressor module 100 is installed.

The liquid reservoir 119 accumulates the refrigerant that has condensed and liquefied during the shutdown of the operation. Therefore, the refrigerant, which has condensed and liquefied during the shutdown of the operation, can be limited from flowing into the compressor 11 at the time of restarting the compressor 11.

In the first and second embodiments described above, the accumulator 20 is positioned on the lower side of the flow passage plate 110 so that the refrigerant, which has condensed during the shutdown of the operation, is more likely to be accumulated in the accumulator 20. This is because the refrigerant, which has condensed and liquefied during the shutdown of the operation, is more likely to flow down from the flow passage plate 110 to the accumulator 20 due to the gravity.

In contrast, in the present embodiment, since the liquid reservoir 119 is formed, it is possible to accumulate the liquid-phase refrigerant inside the flow passage plate 110. Therefore, besides positioning the accumulator 20 on the lower side of the flow passage plate 110, the accumulator 20 may also be positioned on the lateral side or the upper side of the flow passage plate 110.

In the first and second embodiments described above, the air conditioning chiller 18 is positioned on the upper side of the flow passage plate 110, and the accumulator 20 is positioned on the lower side of the flow passage plate 110 so that the refrigerant, which has condensed in the air conditioning chiller 18 during the shutdown of the operation, is more likely to be accumulated in the accumulator 20. This is because the refrigerant, which has condensed and liquefied in the air conditioning chiller 18 during the shutdown of the operation, is more likely to flow down to the accumulator 20 due to the gravity. This limits the refrigerant, which has condensed and liquefied in the air conditioning chiller 18 during the shutdown of the operation, from flowing into the compressor 11 through the bypass flow passage 25 at the time of restarting the compressor 11.

On the other hand, when the liquid reservoir 119 of the present embodiment is formed in the bypass flow passage 25, it can limit the refrigerant, which has condensed and liquefied in the air conditioning chiller 18 during the shutdown of the operation, from flowing into the compressor 11 through the bypass flow passage 25 at the time of restarting the compressor 11. Therefore, it becomes possible to position the air conditioning chiller 18 on the lower side of the flow passage plate 110.

As in the second embodiment described above, when the suction-side refrigerant flow passage 28 is formed inside the flow passage plate 110, the liquid reservoir 119 may also be formed in the suction-side refrigerant flow passage 28.

In the present embodiment, the flow passage plate 110 has the liquid reservoir 119 that is recessed toward the lower side at the refrigerant flow passage 118 to accumulate the liquid-phase refrigerant at the liquid reservoir 119.

As a result, the refrigerant, which has liquified during the time of stopping the compressor 11, is accumulated in the liquid reservoir 119, thereby limiting the liquefied refrigerant from flowing down into the compressor 11 due to the gravity. Therefore, it is possible to limit the occurrence of the liquid compression in the compressor 11 at the time of restarting the compressor 11.

The present disclosure is not limited to the above-described embodiments and may be modified in various ways as follows without departing from the spirit of the present disclosure.

In the embodiments described above, the vehicle air conditioning apparatus 1 has been described as the heat pump cycle apparatus to which the compressor module is applied. However, the heat pump cycle apparatus, to which the compressor module is applied, is not limited to the vehicle air conditioning apparatus.

For example, the heat pump cycle apparatus may be a stationary air conditioning apparatus with a temperature control function that adjusts the temperature of the temperature adjusting subjects (e.g., computers, computer server devices, and other electric devices) while performing indoor air conditioning.

Furthermore, in the embodiments described above, there is described the example in which the temperature of the in-vehicle device, specifically the battery, is adjusted. However, the in-vehicle device is not limited to the battery. For example, it may be configured to adjust the temperature of an inverter, a PCU, a transaxle and/or a control device for ADAS.

The inverter supplies the electric power to, for example, a motor generator. The PCU is a power control unit that performs the power transformation function and the power distribution function. The transaxle is a drive force transmission mechanism that integrates the transmission, differential gears, and the like. The control device for ADAS is a control device for the advanced driver assistance system(s).

The specific configuration of the compressor module 100 is not limited to the configuration disclosed in the above embodiments.

For example, the constituent devices of the heat pump cycle 10 integrated into the compressor module 100 are not limited to the constituent devices disclosed in the above embodiments. As long as the compressor 11, the at least one evaporator and the accumulator 20 are integrated at the flow passage plate 110, the other constituent device(s) may or may not be integrated at the flow passage plate 110.

In the embodiments described above, there is described the example in which the aluminum alloy was used as the material for forming the flow passage plate 110, but the material of the flow passage plate 110 is not limited to the aluminum alloy.

The specific configuration of the heat pump cycle apparatus, to which the compressor module is applied, is not limited to the configuration disclosed in the embodiments described above.

For example, the refrigerant of the heat pump cycle 10 is not limited to R1234yf. As the refrigerant, R134a, R600a, R410A, R404A, R32, R407C or the like may be used. Alternatively, a mixed refrigerant composed of a combination of a plurality of refrigerants among these refrigerants may be used.

For example, each of the high-temperature heat medium in the high-temperature heat medium circuit 30, the low-temperature heat medium in the first low-temperature heat medium circuit 40 and the low-temperature heat medium in the second low-temperature heat medium circuit 50 is not limited to the ethylene glycol aqueous solution. The high-temperature heat medium and/or the low-temperature heat medium may be, for example, a solution containing dimethylpolysiloxane or nanofluid; antifreeze; an aqueous liquid refrigerant containing alcohol; or a liquid media containing oil.

The specific operation of the heat pump cycle 10, to which the compressor module is applied, is not limited to the configuration disclosed in the embodiments described above.

The refrigerant flow passage inside the flow passage plate 110 may be inclined or stepped so that the refrigerant flow passage, which is inside the flow passage plate 110, descends towards the accumulator 20.

As a result, since the refrigerant, which has condensed during the shutdown of the operation, is likely to naturally flow down due to the gravity and is accumulated in the accumulator 20, it is possible to limit the refrigerant, which has condensed during the shutdown of the operation, from flowing into the compressor 11 at the time of restarting the compressor 11.

In the embodiments described above, the flow passage plate 110 is formed by the casting. However, the flow passage plate 110 may also be formed by bonding metal plates or combining machined blocks.

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A compressor module comprising:
an evaporator configured to evaporate a refrigerant of a vapor compression refrigeration cycle;
a liquid storage configured to store the refrigerant in a liquid phase;
a compressor configured to suction and compress the refrigerant; and
a flow passage forming member to which the evaporator, the liquid storage and the compressor are installed, wherein:
the flow passage forming member forms at least a portion of a flow passage of the refrigerant;
the compressor is positioned on a lower side of the flow passage forming member; and
the flow passage of the refrigerant includes a suction-side refrigerant flow passage, through which the refrigerant in a gas phase to be suctioned into the compressor flows, wherein the suction-side refrigerant flow passage has a rising portion that rises upward as the rising portion approaches the compressor.

2. The compressor module according to claim 1, wherein the liquid storage is positioned on the lower side of the flow passage forming member.

3. The compressor module according to claim 1, wherein the evaporator is positioned on an upper side of the flow passage forming member.

4. The compressor module according to claim 1, comprising a suction-side refrigerant pipe that is a pipe member which forms a passage of the refrigerant extending from the flow passage forming member to the compressor in the suction-side refrigerant flow passage, wherein:
the flow passage forming member has a suction-side refrigerant outlet which is configured to output the refrigerant and is joined with the suction-side refrigerant pipe; and
the suction-side refrigerant pipe rises upward from the suction-side refrigerant outlet to form the rising portion.

5. The compressor module according to claim 1, wherein:
the flow passage forming member is a member shaped in a plate form which extends in a horizontal direction; and
the compressor is fixed to a lower surface of the flow passage forming member.

6. The compressor module according to claim 1, wherein the flow passage forming member has a liquid reservoir that is recessed toward the lower side at the flow passage of the refrigerant to accumulate the refrigerant in the liquid phase at the liquid reservoir.

7. The compressor module according to claim 1, wherein the rising portion is formed inside the flow passage forming member.
